(19) United States
(12) Patent Application Publication
(10) Pub. No.: US 2008/0016274 A1
(43) Pub. Date: Jan. 17, 2008

(54) Method of protecting cache memory data in storage system

(76) Inventors: Xing-Jia Wang, Tianjin (CN); Jian-Feng Guo, Tianjin (CN); Cang-Mou Cao, Tianjin (CN); Yi Chen, Tianjin (CN); Tom Chen, Taipei (TW); Win-Harn Liu, Taipei (TW)

Correspondence Address: HARNESS, DICKEY & PIERCE, P.L.C., P.O. BOX 8910, RESTON, VA, 20195, US

(21) Appl. No.: 11/485,528

(22) Filed: Jul. 13, 2006

(51) Int. Cl. G06F 13/00; G06F 12/16

(52) U.S. Cl. 711/113; 711/162

(57) ABSTRACT

A method of protecting the cache memory data in a storage system is used to protect the data in the cache memory of a battery backed storage system. The method provides a preserved area in the random access memory (RAM) of the system for storing the information of disk cache items. When the storage system has a power failure, the battery backed function provides power to protect the data stored in the RAM of the system being lost. When the storage system resumes, the information stored in the preserved area preserves the data stored in the disk cache of the system RAM. After the storage system resumes, the data stored in the disk cache of the RAM of the system are written into the corresponding block device. These implement the power failure protection for the data stored in the disk cache of the RAM of the system.

### BACKGROUND OF THE INVENTION

1. Field of Invention

The present invention relates to a data protection method; and more particularly, to a method of protecting data in the cache memory of a storage system.

2. Related Art

In a computer system, the operation speed of the central processing unit (CPU) is very fast. However, it takes a long time to directly access block devices, such as the hard disk drive (HDD), SCSI HDD, HDD array, etc. In the beginning, the CPU accesses the block devices in a programmed input/output (PIO) means. That is, the CPU has to wait until the I/O operation on the block device is done before it can continue with subsequent task. This largely wastes the CPU working time and resources. To solve this problem, an interruption means is adopted. That is, the CPU can execute other tasks while accessing and operating in the block device. Once the access operation on the block device is finished, an external device triggers an interrupt and then the CPU can continue next tasks. This increases the efficiency of the CPU. However, this method does not make full use of the characters of random access memory (RAM) that has a faster I/O speed. Therefore, a method of using the disk cache is proposed to increase the system efficiency. That is, a part of the RAM in the system is used as the disk cache for the access operation of the block device. When writing to the device, the information of data to be written, the device name, and the location in the device are recorded in the disk cache. The CPU then considers that the writing operation is over. Afterwards, the I/O device in the system is devoted to perform the writing operation for the data stored in the disk cache periodically or when the RAM resources of the system are insufficient, but the data in the disk cache are preserved. When reading from the device, the CPU first determines whether the disk cache is stored with the data to be read. If there has, then the data are directly read out. Otherwise, the CPU sends out a task of reading the device. The current task is preserved, and the CPU can perform other tasks. After the data are read from the device, the data are added into the disk cache. At the same time, an interrupt signal is sent to the CPU, so that the CPU can keep executing the reading operation for the device. To increase the I/O efficiency of the block device, the block device driver usually adopts some efficiency enhancing method, such as the ladder algorithm, the pre-reading algorithm, and delay writing algorithm.

Each item in the disk cache items of the operating system (OS) represents a physical memory page or block. The management of the disk cache usually adopts one of the following methods: the disk cache is normally stored in the three least recently used (LRU) linked lists of dirty, clean, and lock. The dirty linked list includes all the disk cache items which need to be written into the block device. The lock linked list includes the disk cache items which are writing to the block device. The clean linked list includes the most recent data already stored in the disk cache of the block device. Therefore, the disk cache items migrate among the three linked lists. When the CPU performs a writing operation to the block device, it first checks whether there have corresponding disk cache items in the clean linked list. If yes, then the corresponding disk cache items are deleted from the clean linked list. The data in the disk cache items are modified, and the disk cache items are added to the dirty linked list. If no, then the RAM of the system allocates the disk cache items, modifies the data in the disk cache items, and adds the disk cache items to the dirty linked list. Afterwards, the CPU employs the writing operation of the block device to add part of the disk cache items in the dirty linked list to the lock linked list for writing to the block device in a fixed time interval, when the RAM of the system has insufficient resources, when the RAM space occupied by the disk cache reaches the upper limit set by the user, or when the user forces to clean the disk cache. The disk cache items after being written are added to the clean linked list. The LRU disk cache items in the clean linked list are deleted. The deleted disk cache items are re-used to the free RAM of the system for the system to use. In a system whose primary job is for storage, a lot of RAM is used as the disk cache.

However, the processes of adding the disk cache items to the dirty linked list and adding the disk cache items written into the block device to the clean linked list are non-synchronous. Usually, the former process is faster. Therefore, if the disk cache stores data that are not written into a physical block device, once the system has a power failure, the data in the disk cache will be lost. Therefore, this part of data has to be protected and processed in storage products (such as SAN, NAS, and disk array) that have higher requirements of data integrity and security. Many manufacturers provide a battery backed RAM solution.

The commonly seen battery backed solution includes a RAID adapter, a smart array, and a battery backed RAM adapter. Each of them is a device of the computer system and has its own driving program that can speed up the data writing speed and accelerate the data flowing. The data in the disk cache of the RAM of the computer system are transferred to the internal buffer of the device for processing. In particular, the RAID adapter or the smart array writes the data in its buffer into a storage device coupled to it. The battery backed RAM adapter only stores data. Since they all have the battery backed function, they can maintain the data stored in their internal buffer for a certain period of time without losing them if power failure. Once the system returns to normal, the data in the buffer can be written into the storage device. However, the solution in the prior art can only protect the data transferred from the RAM of the storage system to the internal buffer. It cannot protect the data stored in the disk cache of the RAM of the computer system.

### SUMMARY OF THE INVENTION

To solve the above-mentioned problems and drawbacks, an object of the invention is to provide a method of protecting data in the cache memory of a storage system. When the computer system has a power failure, the data stored in the cache memory of the battery backed storage system can be protected by utilizing the present invention.

The disclosed method of protecting data in the cache memory of a storage system includes the following steps. When the storage system starts, a preserved area with an appropriate length is preserved at an appropriate beginning position in the RAM of the storage system. After the storage system runs, it monitors the operation of the dirty linked list and the clean linked list. When the system adds a disk cache item to the dirty linked list, the serial number of an entry in the preserved area is computed in accord with the position of the disk cache item in the RAM. The information of the position of the disk cache item in the RAM, the size of the disk cache item in the RAM, the name of block device written with the disk cache item, and the position of the disk cache item in the block device is written to the entry. When the system adds one disk cache item to the clean linked list, a serial number of an entry of the preserved area is computed according to the position of the disk cache item in the RAM. The information stored in the entry is removed. When the storage system has a power failure, the RAM is powered by the battery backed function. When the storage system resumes, the position and size information of the disk cache items stored at a plurality of entries in the preserved area is read. The data stored at the corresponding positions in the RAM are preserved according to the position and size information. After the storage system resumes, the information of the disk cache items stored at the entries in the preserved area are read. The data stored at the corresponding positions in the RAM are written to the corresponding block device in accord with the information. The preserved RAM space is released and the value of each entry in the preserved area is set to zero.

The appropriate beginning position of the preserved area is the position other than the RAM position needed for the initialization of the operating system (OS) and the mapping position of the hardware in the RAM. The appropriate length is computed using the following formula: ((RAM size)/(disk cache item size)+1)*(entry size of the preserved area)+(UUID size). UUID is a universal unique identifier. The entry serial number of the preserved area is computed using the following formula: (position of the disk cache item in RAM)/(disk cache item size).

In summary, the invention utilizes the battery backed function of the computer system to implement the power failure protection function for data stored in the disk cache of the RAM of the computer system.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1 is a flowchart of the method of protecting data in the cache memory of a storage system of the present invention.

### DETAILED DESCRIPTION OF THE INVENTION

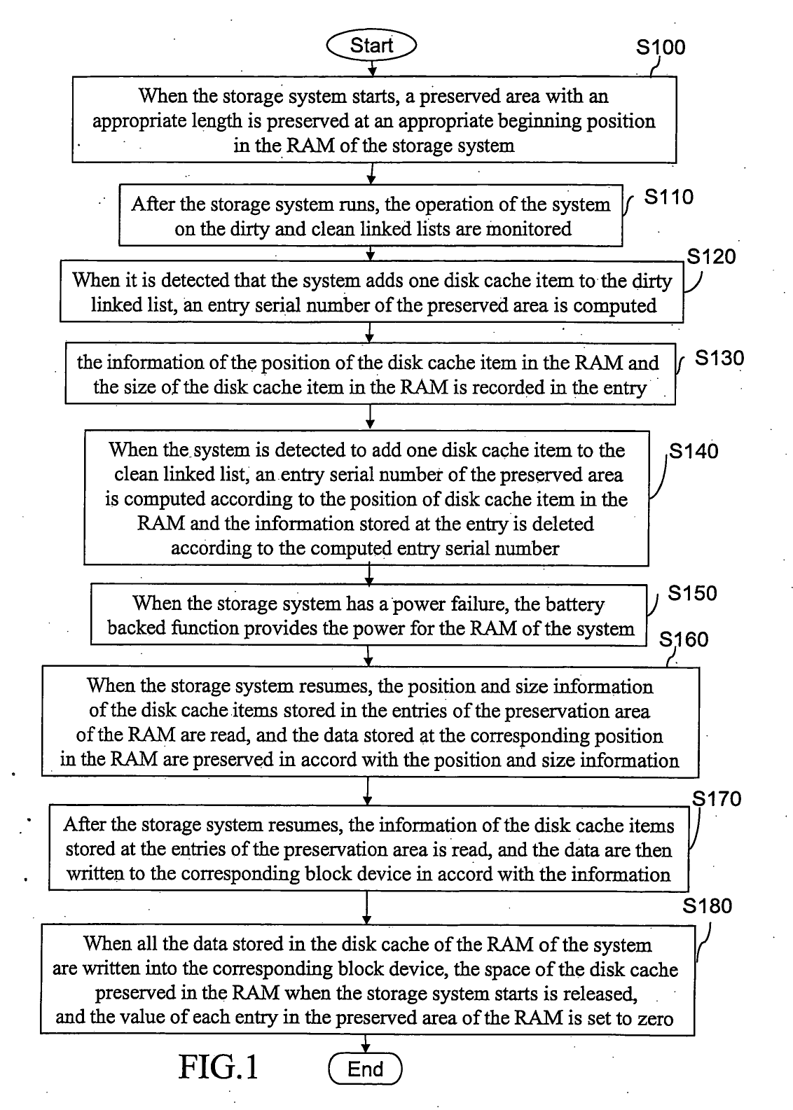

The flowchart of the method of protecting data in the cache memory of a storage system is illustrated in FIG. 1. The method includes the following steps.

When the storage system starts, a preserved area with an appropriate length is preserved at an appropriate beginning position in the RAM of the storage system (S100). The appropriate beginning position of the preserved area is the position other than the RAM position needed for the initialization of the OS and the mapping position of the hardware in the RAM. The appropriate length is computed using the following formula: ((RAM size)/(disk cache item size)+1)*(entry size of the preserved area)+(UUID size). UUID is a universal unique identifier. When the OS of the storage system establishes the management mechanism of the memory visit area needed by the OS, the beginning position of the preserved area and the length are added in order to preserve the preserved area.

After the storage system runs, the operation of the system on the dirty and clean linked lists are monitored (S110). When it is detected that the system adds one disk cache item to the dirty linked list, an entry serial number of the preserved area is computed using the following formula: (position of disk cache item in RAM)/(disk cache item size) (S120). In accord with the computed entry serial number, the information of the position of the disk cache item in the RAM and the size of the disk cache item in the RAM is recorded in the entry (S130). When the system is detected to add one disk cache item to the clean linked list, an entry serial number of the preserved area is computed according to the position of disk cache item in the RAM using the following formula: (position of disk cache item in RAM) (disk cache item size). The information stored at the entry is deleted according to the computed entry serial number (S140).

When the storage system has a power failure, the battery backed function provides the power for the RAM of the system, protecting the data stored therein. It also provides a short-term power for the CPU of the storage system, so that the CPU can complete the task of synchronizing the data in the cache memory of the CPU to the RAM of the system (S150).

When the storage system resumes, the self test parameters of RAM in the basic input/output system (BIOS) of the storage system are modified to protect all the data stored in the RAM of the system. The preservation process of S100 is repeated. The position and size information of the disk cache items stored in the entries of the preservation area of the RAM of S100 are read. The data stored at the corresponding position in the RAM are preserved in accord with the position and size information (S160).

After the storage system resumes, the information of the disk cache items stored at each entry of the preservation area is read. The information is used to find the RAM at the corresponding position. The information of data to be written to the disk cache items, the name of the block device to be written with the disk cache items, and the position of the disk cache items in the block device is read from the corresponding position of the RAM. The data are then written to the corresponding block device in accord with the information (S170). These implement the protection for the data stored in the disk cache of the RAM of the system.

When all the data stored in the disk cache of the RAM of the system are written into the corresponding block device, the space of the disk cache preserved in the RAM when the storage system starts is released. The value of each entry in the preserved area of the RAM is set to zero (S180).

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of protecting data stored in the cache memory of a storage system for protecting the data in the cache memory of a battery backed storage system, the method comprising the steps of:
preserving an area with an appropriate length in an appropriate beginning position of the random access memory (RAM) of the storage system when the storage system starts;
monitoring the operation of a dirty linked list and a clean linked list and storing or deleting the information of a disk cache item in the preserved area in accord with the monitored operation after the storage system starts;
providing power to the RAM by the battery backed function for protecting the data stored in the RAM when the storage system has a power failure;
reading the information of the disk cache item stored in the preserved area and preserving the corresponding data stored in the RAM in accord with the information when the storage system resumes; and
reading the information of the disk cache item stored in the preserved area and writing the corresponding data stored in the RAM into the corresponding block device in accord with the information after the storage system resumes.

2. The method of claim 1 further comprising the step of releasing the space of the preserved RAM and setting the values of a plurality of entries in the preserved area to zero.

3. The method of claim 1, wherein the appropriate beginning position is a position other than the position of the RAM needed for initializing the operating system of the storage system and the mapping position of the hardware in the RAM.

4. The method of claim 1, wherein the appropriate length is computed using the following formula: ((RAM size)/(disk cache item size)+1)*(entry size of the preserved area)+(UUID size), where UUID is a universal unique identifier.

5. The method of claim 1, wherein the process of preserving the preserved area is achieved by adding the information of the beginning position and length of the preserved area to a management mechanism of the memory visit area needed for starting the operating system (OS) that is established by the OS of the storage system.

6. The method of claim 1, wherein the information of the disk cache item includes the position of the disk cache item in the RAM and the size of the disk cache item.

7. The method of claim 1, wherein the step of storing or deleting information of a disk cache item in the preserved area in accord with the monitored operation further includes the steps of:
computing a serial number of an entry of the preserved area according to the position of the disk cache item in the RAM when adding one disk cache item to the dirty linked list;
storing the information of the position of the disk cache item in the RAM and the size of the disk cache item to the entry; and
computing a serial number of an entry of the preserved area according to the position of the disk cache item in the RAM and deleting the information stored in the entry when adding one disk cache item to the clean linked list.

8. The method of claim 7, wherein the entry serial number is computed using the following formula: (position of disk cache item in RAM)/(disk cache item size).
